(19) United States
(12) Patent Application Publication
(10) Pub. No.: US 2008/0235613 A1
(43) Pub. Date: Sep. 25, 2008

(54) APPLIANCE WITH USER INTERFACE HAVING MULTI-USER MODE

(75) Inventors: Michael RICKLEFS, Webster City, IA (US); Marco DEL PUPPO, Polcenigo (IT); Fabio MARCHETTO, Oderzo (IT); Steve JOERGER, Ames, IA (US); Timothy SHANAHAN, Ames, IA (US); Ha Young COFFMAN, Atlanta, GA (US); Michael MOORE, Webster City, IA (US); Loween J. CLAYBERG, Webster City, IA (US); Sean MYERS, Ames, IA (US); Robert A. McCOY, Franklin, TN (US); Charlotte BRUNDIN-LEWIS, Anderson, SC (US)

Correspondence Address: BANNER & WITCOFF, LTD.;ATTORNEYS FOR CLIENT NOS. 006912 AND 026912, 1100 13th STREET, N.W., SUITE 1200, WASHINGTON, DC, 20005-4051, US

(73) Assignee: ELECTROLUX HOME PRODUCTS, Cleveland, OH (US)

(21) Appl. No.: 11/690,324

(22) Filed: Mar. 23, 2007

(51) Int. Cl. G06F 3/048

(52) U.S. Cl. 715/779

(57) ABSTRACT

In accordance with the present disclosure, a system for providing a customizable multi-user interface for a treatment appliance is presented. The system includes a user interface having a display region. The display region may include a user selection menu wherein one of a plurality of stored users may be selected. Once a user is selected, various customized user interface parameters and wash cycles associated with that user will be available for selection. The customized user interface parameters may include brightness, contrast, volume, and the like. Each cycle may include various customized wash cycle parameters, such as wash temperature, spin speed and soil level. The user interface may further include a plurality of soft keys provided for the selection of menu options on the display. In addition, the user interface may include a rotatable knob from which cycle selections may be made.

### TECHNICAL FIELD

A user interface for an appliance. More specifically, this application deals with a customizable user interface for an appliance, such as a clothes washer, clothes dryer, oven or microwave oven, that includes multiple users having customizable cycles.

### BACKGROUND

Conventional automatic washing machines generally employ various wash cycle options. For instance, a washing machine includes a normal cycle as well as a gentle cycle. In addition, various wash cycle parameters can be adjusted to provide a wash cycle that meets the needs of the user. For instance, the water temperature may be adjusted between hot, warm or cold and the wash cycle can include an extra rinse cycle. Adjustment of these parameters allows a user to somewhat customize the wash cycle to meet his or her needs, however the wash cycle parameters must be set each time the washer is used.

Some automatic washing machines include the ability to save a wash cycle once the parameters have been set. This cycle then becomes part of a database using the available wash cycle choices that can potentially be used with a given wash load. However, for households with several members performing laundry functions, or housing situations in which various people are using the same laundry facilities, merely saving a given cycle into a database of choices does not provide the needed level of convenience for many users.

### SUMMARY

In accordance with the present disclosure, a system for providing multi-user capability to an appliance is presented. The system includes a user interface having a display region. The display region may include a user selection menu wherein one of a plurality of stored users may be selected. Once a user is selected, various customized wash cycles associated with that user will be available for selection. Each cycle may include various customized wash cycle parameters, such as wash temperature, spin speed and soil level.

The user interface may further include a plurality of soft keys provided for the selection of menu options on the display. In addition, the user interface may include a rotatable knob from which cycle selections may be made.

These and additional features and advantages of the invention disclosed here will be further understood from the following detailed description.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIGS. 1A-1D are various appliances that may be used with a user interface having a multi-user mode as provided herein.

FIGS. 2A-2E illustrate various types of user interfaces that may be used with the multi-user mode provided herein.

FIGS. 3A-3D illustrate examples of sequentially displayed menus associated with a user interface according to aspects of the multi-user arrangement provided herein.

FIGS. 4A-4D illustrate a user interface displaying customizable appliance parameters for a treatment appliance.

FIG. 5 is an example of a user interface including a display region, selectable soft keys and a rotatable selection knob.

FIG. 6 illustrates one example arrangement of a user interface displaying saved cycles available for selection.

FIGS. 7A-7I illustrate a user interface displaying sequential displays according to the multi-user mode and options for entering users into the multi-user mode according to the arrangement provided herein.

### DETAILED DESCRIPTION

The following discussion and accompanying figures disclose a user interface for use with a treatment appliance. As defined herein, a treatment appliance includes one of a clothes washing machine, clothes dryer, oven, microwave oven, cooking range and dishwasher. The user interface may be incorporated into any type of treatment appliance. For ease of understanding, one arrangement of the user interface will be described as incorporated into an automatic washing machine. The user interface is configured to provide a plurality of customized wash cycles and customized user interface options, determined by the user, and determined by each of a plurality of users.

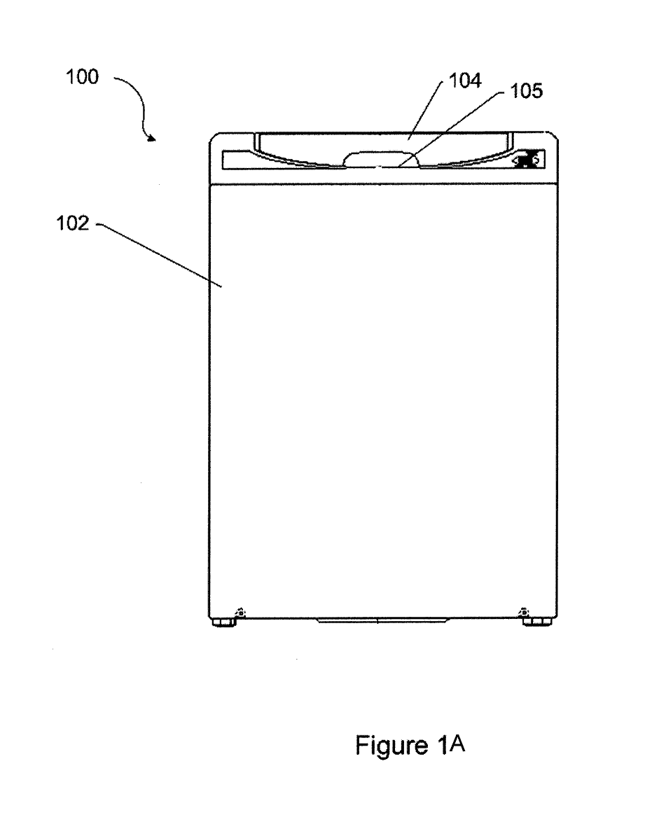

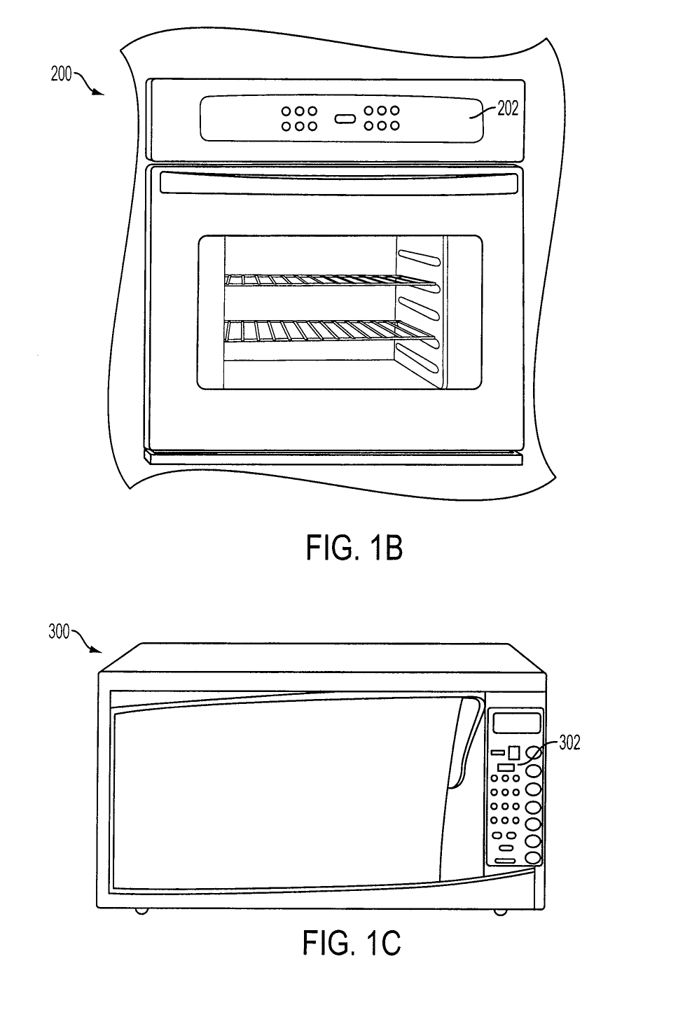

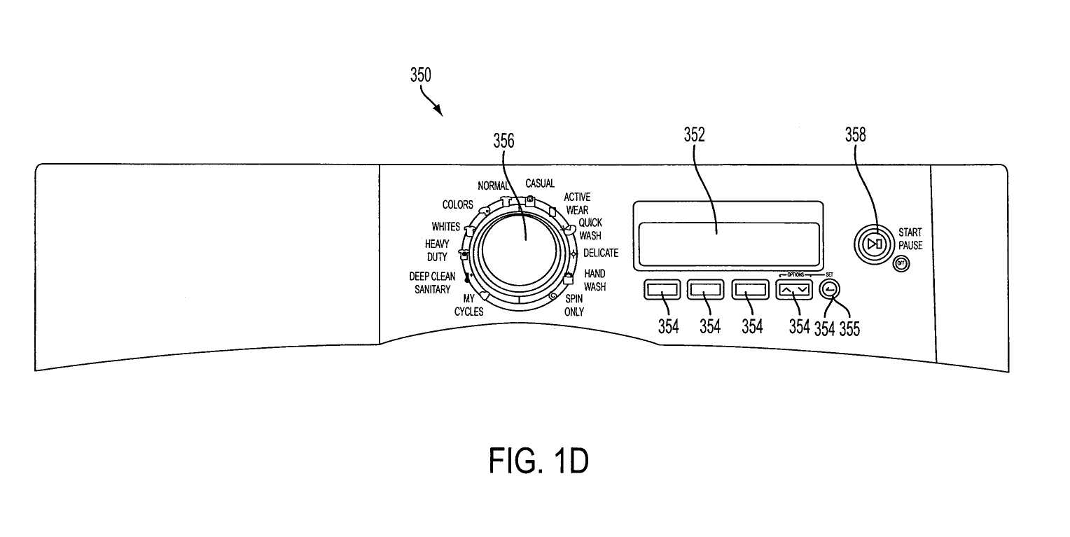

For purposes of general reference, an automatic washing machine 100 is shown in FIG. 1A. The washing machine 100 includes a housing 102, a lid 105 with hinge attached to the housing 102 and a user interface 104. FIG. 1B shows an oven 200 having a user interface 202 and FIG. 1C shows a microwave oven 300 having a user interface 302. It is known that each of these devices will include any desired structures for accomplishing basic appliance tasks. For example, a washing machine typically includes a rotating drum, water inlet and outlet, etc. In yet another example, an oven generally includes a heating element, a temperature control device, etc. While aspects of the multi-user mode will be discussed in the context of these appliances, the user interface described below may be used with any household appliance.

FIG. 1D illustrates one example user interface that may be used in accordance with the multi-user mode described herein. The user interface 350 generally includes a display region 352 and a plurality of function keys 354, such as soft keys, associated with the display region 352. In one arrangement, four soft keys 354 are used in conjunction with the display region 352. In another arrangement, a fifth soft key 355 may be provided for additional functionality. The user interface 350 also includes a rotatable selection knob 356. The knob 356 may be used to select a cycle from a plurality of available cycles. A start button or option 358 may also be provided on the user interface 350.

Various general aspects of the user interface having a multi-user mode will be discussed in the context of the washing machine shown in FIG. 1A, and the example user interface shown in FIG. 1D. The appliance may include a general computing environment, positioned within a housing, which can be used to implement various aspects of the present invention. The general computing environment may include any typical electrical interfaces and/or structures to accomplish the basic computing tasks described. The general computing environment may include a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory may include read only memory (ROM) and random access memory (RAM).

The computer also may include a hard disk drive for reading from and writing to a hard disk. This drive and its associated computer-readable media provide nonvolatile storage of computer-readable instructions, data structures, program modules, and other data.

A number of program modules can be stored on the hard disk drive, including an operating system, one or more application programs, other program modules, and program data. The program modules may also be stored on one or more microprocessors. A user can enter commands and information into the computer through input devices, such as a control panel providing a user interface 104. The user interface 104 may be a touch sensitive display, such as a liquid crystal display (LCD) type interface, that allows a user to select various options on the user interface by applying pressure to the LCD screen in the region of the option selected. Other alternative types of user interfaces will be discussed below. Each selection made by the user may prompt the user with another screen where further selections may be made, or may begin an appliance cycle. These and other input devices often are connected to the processing unit through a serial port interface that is coupled to the system bus. Further still, these devices may be coupled directly to the system bus via an appropriate interface.

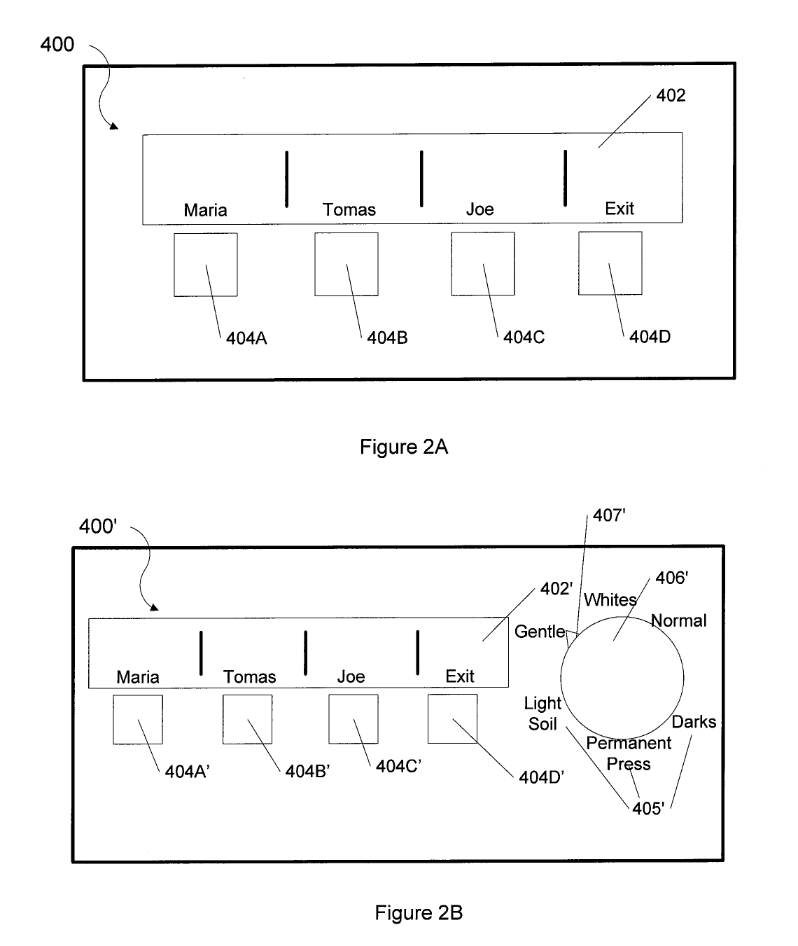

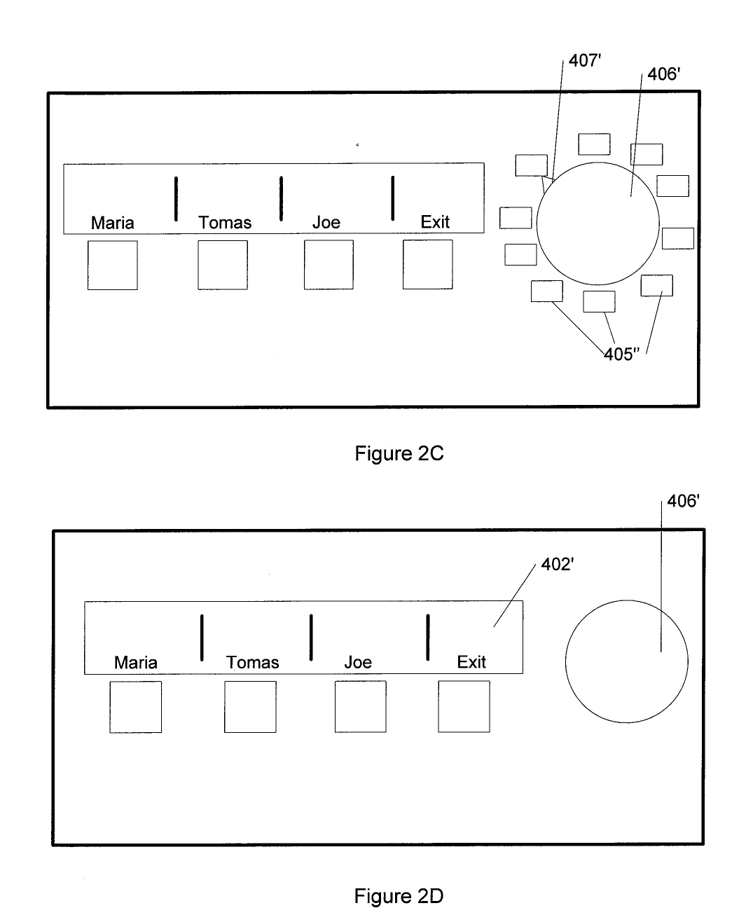

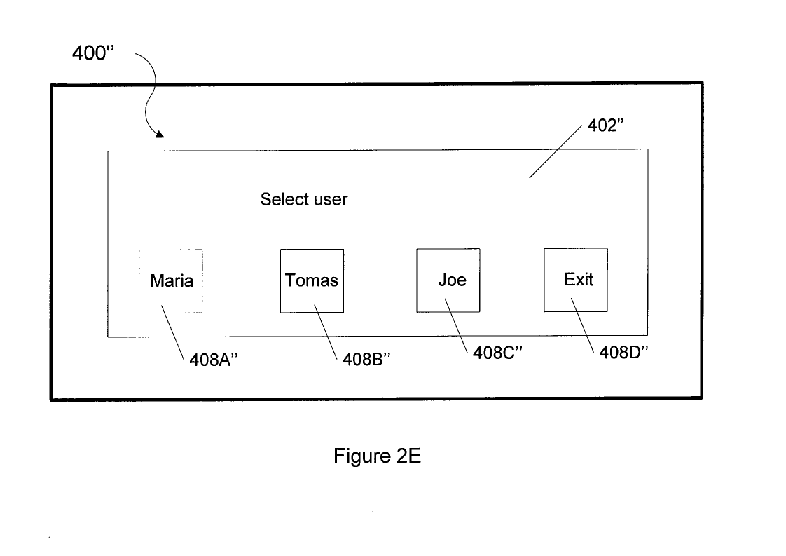

With reference to FIGS. 2A-2E, the user interface 400 may include a display screen 402, as well as various options for making selections on the display screen 402. In one arrangement, shown in FIG. 2A, the display screen 402 may be accompanied by a plurality of function keys. The function keys may include soft keys 404A-404D that are physical keys outside of the display region but positioned to correspond to options on the display screen. The function of the soft key may change depending on the option shown on the display screen. The function keys may also include virtual control elements or icons (408A-408D in FIG. 2E) on a touch sensitive display. The function keys may also include a touch-sensitive keypad positioned outside the display region and adjacent to the display region. As used herein, the term soft key shall be used in describing various embodiments. However, it is recognized that any function performed by a soft key may be performed by a virtual control element or icon, a touch-sensitive keypad, and the like, while remaining within the scope of this disclosure.

The soft keys allow a user to make selections based on the current menu displayed. For instance, the menu displayed in FIG. 2A indicates that different users are available for selection. Once a user determines which user to select, that selection may be made by pressing the soft key corresponding to that user. In FIG. 2A, if a user would like to select Tomas, the user would then press the soft key associated with Tomas on the user interface. Although the figures indicate that the soft keys are located below the menu, the soft keys may be positioned anywhere proximate the display region. For instance, the soft keys may be arranged vertically along a left or right side of the display region. Alternatively or additionally, the soft keys may be arranged across the top of the display region. It should also be noted that, although four soft keys are shown, fewer soft keys may be used or, additional soft keys may be added to provide additional functionality.

FIG. 2B illustrates yet another arrangement for making selections on a user interface. The arrangement of FIG. 2B includes a display region 402′ and a plurality of soft keys 404A′-404D′, similar to the arrangement shown in FIG. 2A. FIG. 2B further includes an additional input device. As shown, the additional input device may be a rotatable knob 406′ that allows users to make selections based on the stopped position of the knob. The rotatable knob 406′ may include a pointer 407′ or other type of indicator to allow a user to identify the selection being made. The pointer or other type of indicator may be part of the rotatable knob 406′ or it may be separate from the knob 406′. In other arrangements, the additional input device may include a plurality of buttons, a touch-sensitive display, and the like.

In the arrangement of FIG. 2B, the rotatable input knob 406′ may allow users to make various selections on the user interface 400′. For instance, the rotatable input knob 406′ may be used in conjunction with the soft keys to make selections from the displayed menu. Additionally or alternatively, the rotatable input knob 406′ may include a plurality of options, arranged about the knob that a user may select based on the position of the knob. For instance, a washing machine may include a plurality of different cycles, i.e., normal, gentle, whites, permanent press, bedding, and the like. A user may select any of these cycles by rotating the input knob to a position in which the pointer 407′ indicates the cycle to be selected. The options associated with the rotatable knob 406′ may include a plurality of printed indicia on the user interface. As shown in FIG. 2B, the printed indicia 405′ may include cycle names available for the washing machine.

FIG. 2C illustrates an alternate arrangement of FIG. 2B wherein the options associated with the rotatable knob 406′ are virtual displays 405″. Such an arrangement provides for various options to be displayed around the rotatable knob 406′ based on the state of the user interface.

FIG. 2D illustrates yet another alternate arrangement of FIG. 2B wherein the rotatable knob 406′ controls options available on the display region 402′. For instance, the rotatable knob 406′ may be used to scroll through various options available for a given cycle. In the arrangement of FIG. 2D, the rotatable knob 406′ may not include an indicator (such as pointer 407′ in FIG. 2C).

FIG. 2E illustrates yet another arrangement for making selections on the user interface 400″. The interface 400″ of FIG. 2E includes a display region 402″ that is touch-sensitive. In order to make a selection from the displayed menu, the user may indicate selection of an option via a virtual control element or icon 408A″-408D″. Touch-sensitive display regions that may be used in this arrangement are generally known in the art.

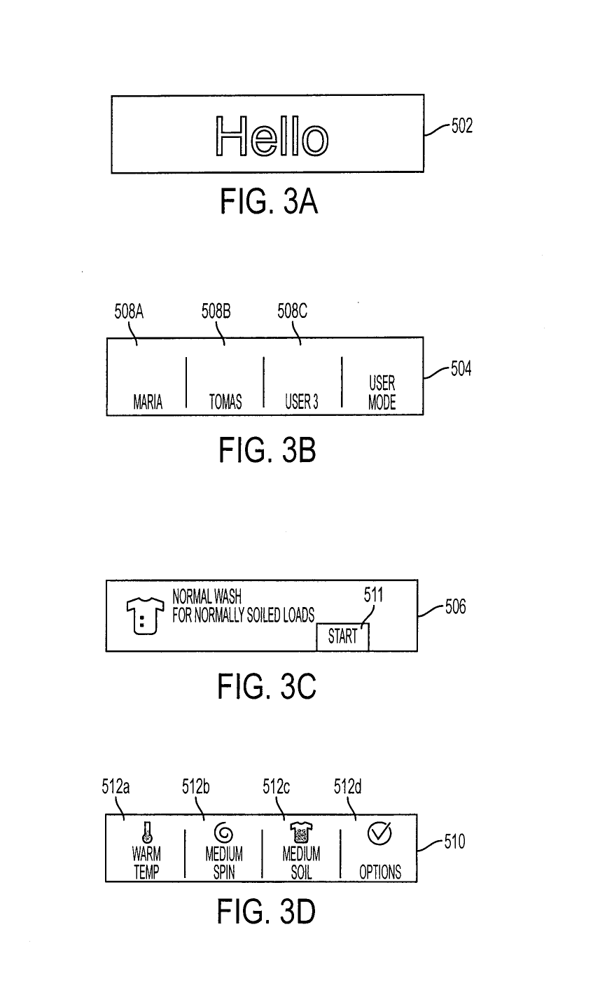

In one arrangement, the control panel or user interface may be arranged on a washing machine and may be used to select a wash cycle from a plurality of wash cycles. For instance, FIGS. 3A-3D illustrate a series of menus that provide a single display screen including a plurality of user selectable options. For instance, FIG. 3A may include a “welcome” type screen 502 that indicates that the appliance was in a sleep mode and is currently awakening or working toward a ready state. It should be noted that the function keys or soft keys have been omitted from FIGS. 3A-3D for simplicity.

Once in a ready state, the appliance may be operating in a multi-user mode. A multi-user mode provides and stores separate profiles for separate users wherein data is stored for each user relating to separate function parameters, such as wash cycle parameters, separate appliance functions, such as wash cycles, or a combination of appliance functions and function parameters. In addition, the data stored for each user may include dating relating to other customizable user interface options. Upon reaching the ready state in multi-user mode, the user interface may display a user selection menu 504, as shown in FIG. 3B. Appearance of the user selection menu 504 may provide an indication that the appliance is operating in multi-user mode, rather than non-multi-user mode, e.g., as a conventional washing machine with manufacturer pre-stored cycles. The user selection menu 504 of FIG. 3B provides at least one user option 508A-508C which, upon selection, may prompt the display of additional menus for selecting a cycle. The display of the at least one user indicates that the appliance is in multi-user mode. FIG. 3B includes three users 508A-508C available for selection. However, additional users may be provided as well. In an arrangement wherein all users may not be visible on the display due to size constraints, a scrolling option may be included to allow a user to scroll through the available names to find the desired selection. Scrolling may be provided by a rocker type switch wherein pressing one side of the rocker switch will scroll through options in one direction and pressing the other side will scroll through options in another direction. Further, scrolling may be provided by pressing any of the function keys, such as soft keys or icons. In addition, scrolling may be provided by the rotatable knob when the knob is not engaged in other aspects of user interface control or selection. In addition, a user preferences option is provided to allow a user to disable the multi-user mode and return it to a non-multi-user mode.

Upon selection of a user from the user selection menu 504, such as Maria, a current cycle parameter indicator page 510, such as shown in FIG. 3C, may be displayed. When in multi-user mode, the current cycle parameter indicator menu 510 may indicate the current cycle setting for the appliance for the user selected from the user selection menu 504. For example, if Maria 508A is chosen from the user selection menu 504, the current cycle parameter indicator menu 510 will display the current cycle set for Maria. In one example shown in FIG. 3C, Maria's current cycle may be a normal cycle. However, if Tomas is selected from the user selection menu 504, the current cycle indicator menu will display Tomas' current cycle which may be permanent press, gentle, etc. In one arrangement, the current cycle displayed on the current cycle parameter indicator page may be the last cycle used by that user. This may include a customized cycle or the factory default settings if the cycle has not been altered. In another arrangement, the current cycle displayed on the current cycle parameter indicator page may be the cycle that the rotatable knob is currently positioned to.

In one multi-user mode arrangement, the parameter of the current cycle will be a cycle customized by the user selected from the user selection menu 504. For instance, Maria's normal cycle may be customized to include various cycle parameter settings selected by that particular user. This allows one user's normal cycle to be different from another user's normal cycle.

For example, once the user is selected and that user's current cycle display appears, the user may change the settings associated with that particular cycle. In order to change the cycle parameter settings, the user may select the parameter to change from the current cycle parameter indicator menu 510, shown in FIG. 3D. In one arrangement, the current cycle parameter indicator menu 510 may appear when a user selects any of the soft keys associated with the current cycle display. In an alternate arrangement, the current cycle parameter indicator menu 510 may be displayed for a predetermined time after the current cycle menu is displayed. For example, once a user is selected, the current cycle menu may appear for five (5) seconds. Once the five seconds has elapsed, the cycle parameter menu will be displayed.

The current cycle parameter indicator menu 510 generally displays the current settings for the current cycle. In one arrangement, the current cycle parameter indicator menu 510 may appear simultaneously with the current cycle page 506. As used herein, the term page may include a user interface display menu or screen. In the example shown in FIG. 3D, the current settings for Maria's normal cycle are warm wash water temperature, a medium spin speed and medium soil level. Thus for each user, the most recently used cycle type with the most recently used parameter may be used as a default. In order to customize the cycle parameters from the current cycle parameter indicator menu 510, the user may select a parameter to change. For example, in order to change the wash temperature from the current displayed setting, the user may select a soft key associated with the temperature portion of the display. Alternatively, if the display is a touch-sensitive display, the user may select the icon associated with the wash temperature.

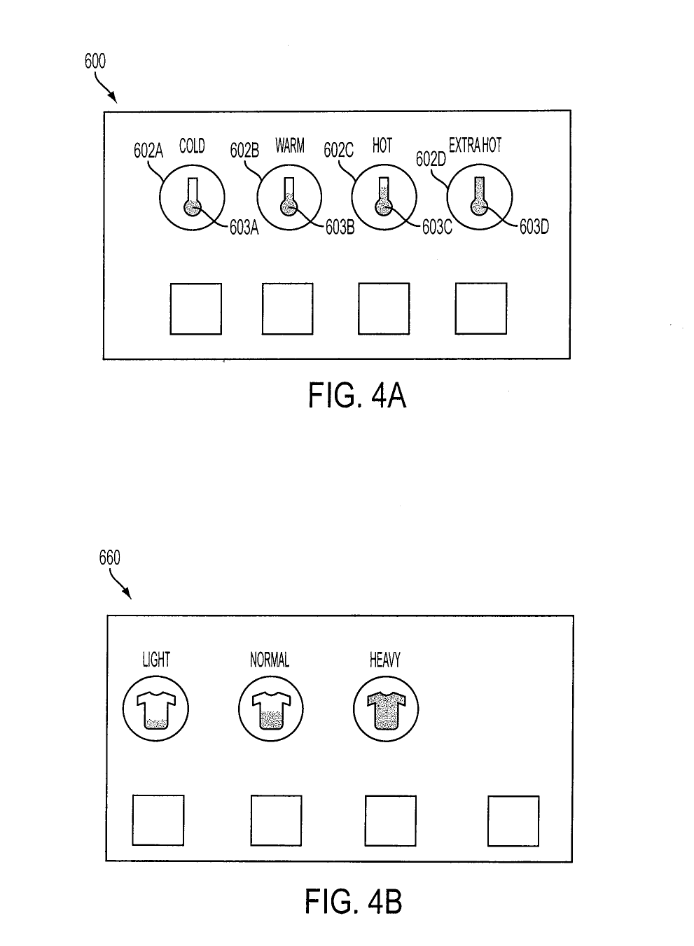

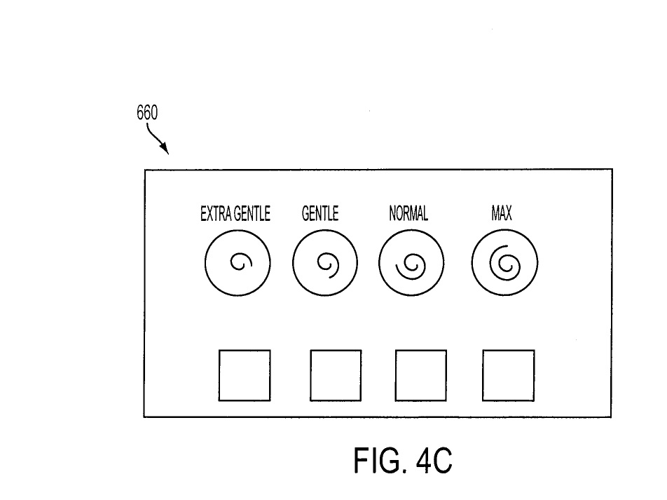

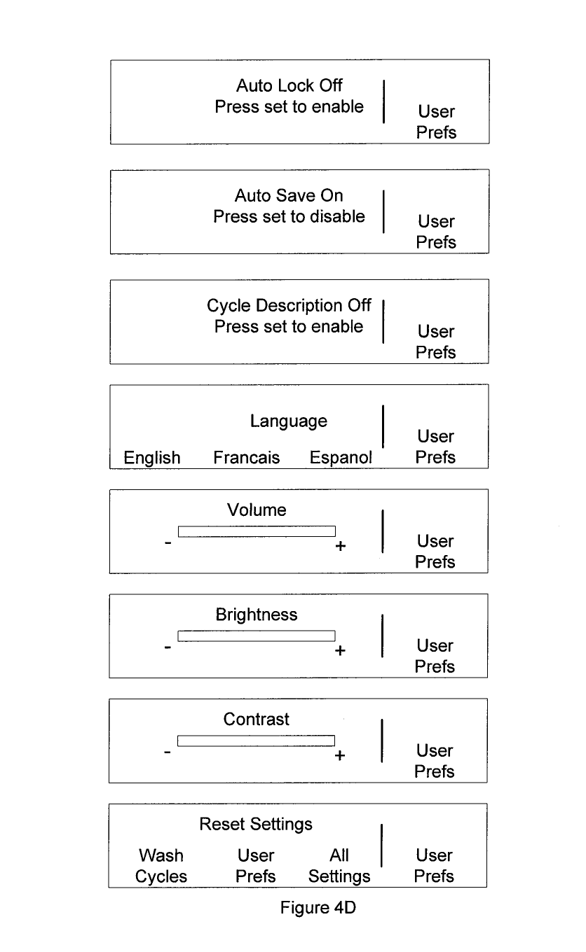

Once the user has selected a cycle parameter to change, a cycle parameter adjustment page is displayed displaying various options for that particular wash cycle parameter. One example of such a specific wash cycle parameter adjustment page 600 is shown in FIG. 4A. For example, the wash cycle parameter adjustment page 600 of FIG. 4A may appear when the soft key associated with wash temperature selected from the current cycle parameter indicator page 510. As shown in FIG. 3D, the wash temperature for the current cycle is set to “warm.” The wash temperature is also graphically illustrated by a wash parameter setting level icon (512a in FIG. 3D). In one arrangement, the wash parameter setting level icon 512a may include an outline of an object indicating the particular wash cycle parameter being adjusted. In such an arrangement, the setting is graphically depicted by contrast of shading in region defined by the outline of the object. In another arrangement, the wash parameter setting level icon need not have an outline. Rather, the icon may be formed by a path and the setting is graphically depicted by the level of a contrasting shading along the path. In both arrangements, the settings are progressively graphically related to the contrasting shading.

In the example of FIG. 4A, the wash temperature setting level icons 602A-602D include an outline of a thermometer with a contrasting tone portion 603A-603D appearing up to a central area to indicate a medium temperature. With icons used in a color LCD arrangement, the contrasting tone portion may include a contrasting color. In an alternate arrangement, the icons indicating a wash parameter may be substantially similar or identical, regardless of the parameter setting. For instance, the thermometer used to indicate the wash temperature may include a contrasting tone portion covering the entire thermometer. This symbol may be used to indicate wash temperature regardless of whether the temperature is set to hot, medium or cold.

Once the desired wash temperature is selected, the user may proceed to customize additional wash cycle parameters. Wash cycle adjustment pages associated with cycle soil level 650 and cycle spin speed 660 are shown in FIGS. 4B and 4C. Each cycle for each particular user may be customized in this manner, thereby providing a plurality of customized cycles for each individual user. When a new user is selected, that user's plurality of customized cycles will be available for selection.

Once the user has identified the desired cycle, the user may start the cycle. In one arrangement, the cycle may automatically begin after a predetermined time elapses. In another arrangement, the user may select a start button to begin the cycle, such as start button 511 in FIG. 3D or start button 358 in FIG. 1D.

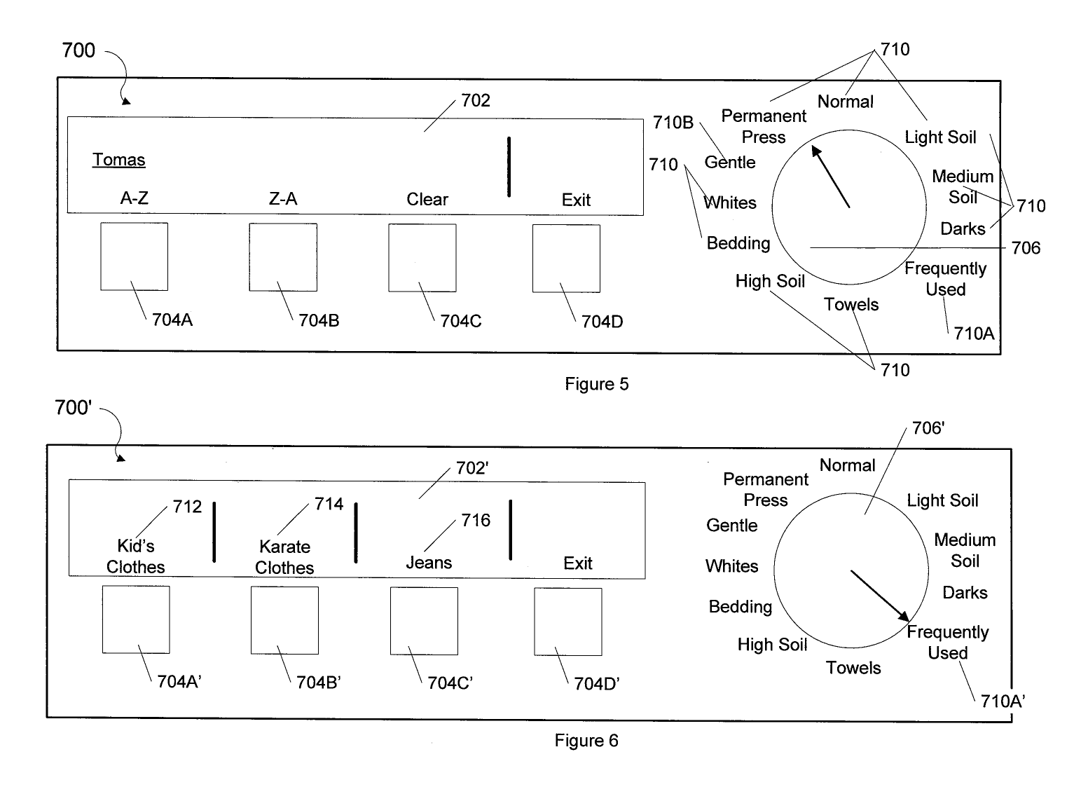

For example, in one arrangement in which a user interface includes a display region, a plurality of soft keys and a rotatable input knob, each user in the multi-user mode may select any of the customized plurality of cycles specific to that user. As shown in FIG. 5, the user has just been selected by selecting the soft key 704A-704D associated with a given user, for instance, Tomas 704B. Once the user is selected, user specific customized cycles and parameters associated with other cycles (associated with Tomas) will be available for selection. In one arrangement, the cycles 710 available for selection may be displayed around the rotatable input knob 706. In such an arrangement, a user may select a cycle 710 based on the position of the knob 706. Accordingly, when the user selects the gentle cycle 710B using the rotatable input knob 706, the current cycle parameter indicator menu 510 will display the cycle parameters that the user has customized for that cycle. For instance, Tomas' gentle cycle may include and cycle parameters used the last time Tomas' gentle cycle was run. Additionally or alternatively, Tomas' cycles may be permanently stored for future use. In one arrangement wherein the user interface includes printed indicia about the rotatable knob, the cycle names may not change. However, selection of a user will cause the parameters associated with the cycle name to change based on the preferences or customization of the user.

Selection of a user also allows for selection of saved, customized, user specific cycles. For instance, the rotatable knob 706 of FIG. 5 includes a selection for customized cycles 710A. The customized cycles 710A option may allow a user to customize cycles and store them for later use, regardless of what one-time changes a user makes to the cycle. For instance, a user may choose to save a cycle for a particular type of clothing, such as kid's clothes. The user may customize the cycle parameters for that particular cycle, using display menus similar to those in FIGS. 4A-4C, and then may save that cycle as “kid's clothes” or some other descriptive name. Once the cycle is saved, it will be available for use by that user when the customized cycles option is selected.

For example, a user may rotate the rotatable input knob 706 to the customized cycles option 710A. Once this selection is made, the display region may display any cycles that have been saved in this option. The user interface 700′ of FIG. 6 shows one illustrative display 702′ of possible customized cycles. The rotatable knob 706′ shown in FIG. 6 is rotated to the customized 710A′ position. The display 702′ includes stored cycle settings for “Kid's Clothes,” 712 “Karate Clothes,” 714 and “Jeans” 716. In order to select one of the cycles, the user may select the soft key 704A′-704D′ associated with that cycle. Although three customized cycles are shown here, any number of cycles may be stored in this option. In an arrangement wherein all available cycles would not be visible on the display because of size constraints, a scrolling option may be included to allow the user to scroll through the available cycle names for selection. As discussed above, scrolling may be accomplished by use of a rocker type button, a plurality of soft keys or icons, the rotatable knob, or other known methods of scrolling.

Selection of a user may also allow for selection of various customizable user interface parameters. For instance, selection of the options item in FIG. 3D may prompt a user to select various setting for additional customizable user options. These options may include LCD brightness, contrast, volume of any audio features on the appliance, language, and the like. A user may also select whether the most recently used cycle settings will be remembered for the next use or whether the factory default will be used on the next wash with that cycle. These options may be customized by each user and saved in each user profile. This may allow users who are older and may not see or hear well to increase LCD brightness and volume when they are selected as the user. At the same time, younger users may select different audio sounds and less LCD brightness. These settings may also be saved and will be provided when that user is selected. Some examples of user interface parameter adjustment pages are shown in FIG. 4D. The example user interface parameter pages may appear sequentially and may advance to the next page by selection of a key or rotation of the knob on the user interface. The options shown in FIG. 4D are examples of various customizable user interface parameters. It is understood that additional customizable parameters may be provided that may be saved in a user profile.

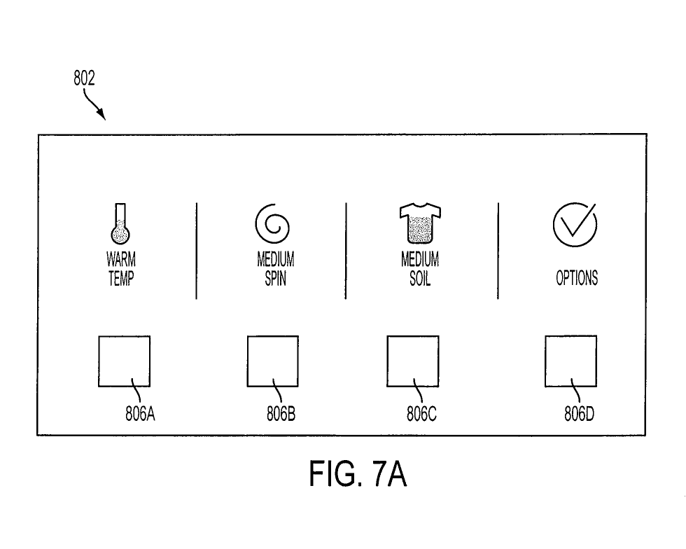

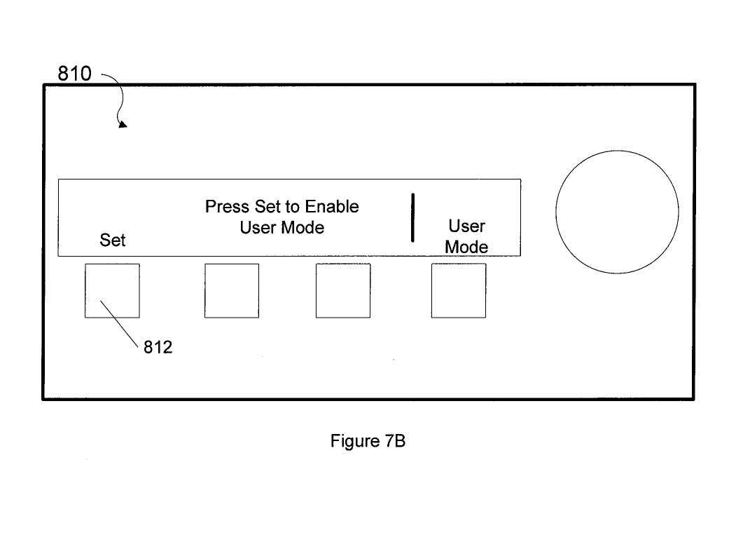

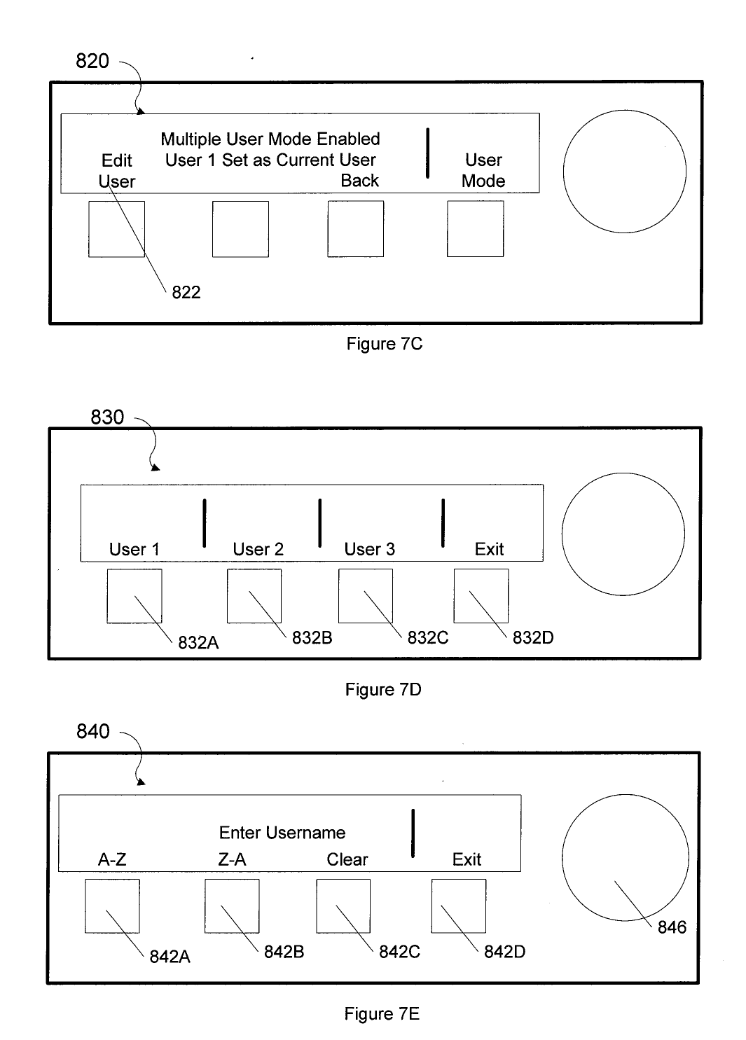

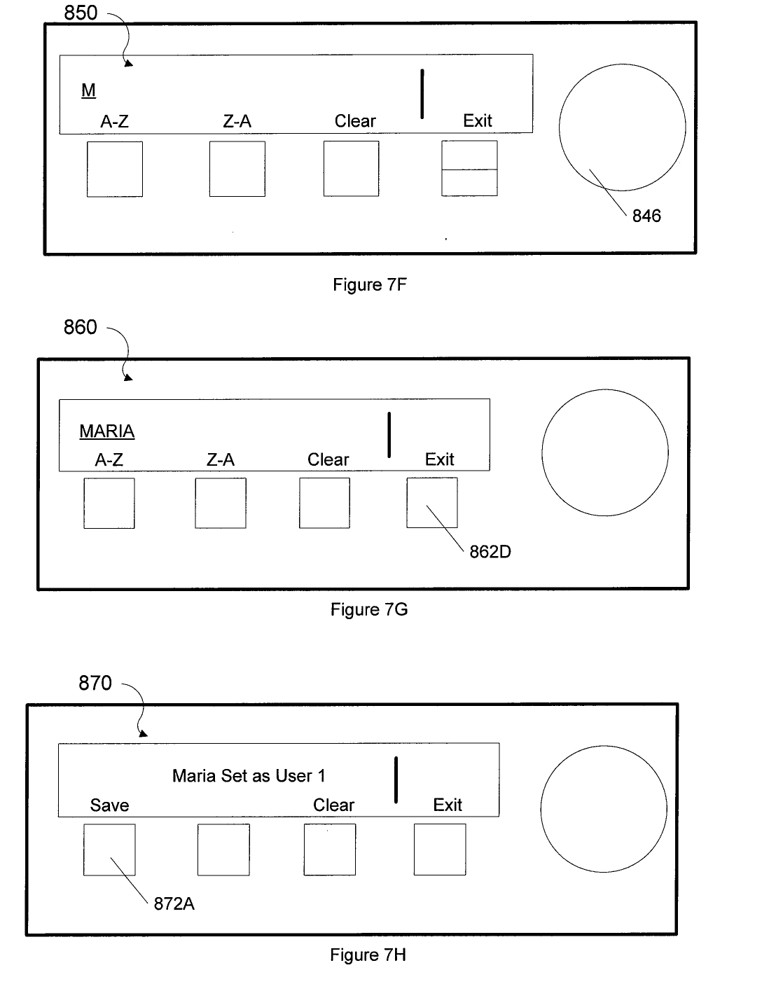

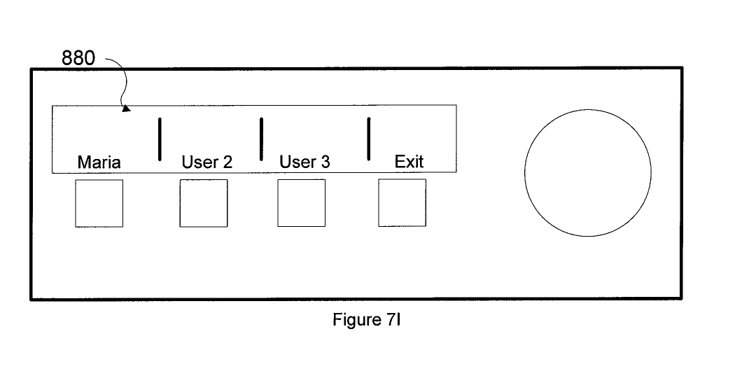

In the multi-user mode, users will be input into and stored in the user interface. In order to store a user, the appliance must be in the multi-user mode. As shown in FIG. 7A, the user mode may be enabled from the current cycle parameter indicator menu 802. This menu 802 may include a user preferences or “options” selection 804. A user may select the soft key 806D associated with the “options” selection 804 in order to prompt a multi-user mode enable menu 810, shown in FIG. 7B. Once the multi-user mode enable menu 810 is displayed, a user may select a soft key associated with a “set” or “enable” button 812A to enable the multi-user mode. Once the multi-user mode has been enabled, a set users screen 820 may be displayed. One example of a set users screen 820 is shown in FIG. 7C. Upon enabling the multi-user mode, all available users may be set to default settings. For example, the user names may be “user 1,” “user 2,” etc. (similar to those shown in FIG. 7D). In addition, the cycles associated with each user may be default cycles. In one arrangement, the default parameters for each user may be the same as the manufacturer pre-stored cycles used in the normal mode. These cycles may then be customized by each user.

Systems for creating customized cycles are generally known in the art. In addition, systems for adding, editing, deleting and selecting users are also generally known in the art. Any of these known methods may be used in accordance with aspects of the multi-user mode. One arrangement of a system for providing these functions is provided below.

In order to change the user name and/or user settings, an “edit user” selection 822 may be made from the set users screen 820. Once the edit user selection 822 has been made, the user selection screen 830 may appear, such as shown in FIG. 7D. A user may then select which user to edit. In order to make a selection, a user may select a soft key 832A-832C associated with the appropriate user. Alternatively, in a touch-sensitive display, a user may select an icon associated with the user to be edited. Once the user to be edited is selected, the user may input a name for this user. FIG. 7E illustrates one example of a user input display 840 for entering a user's name. The user input display menu 840 may include various options for entering a user name. FIG. 7E includes a soft key associated with an a-z scrolling option 842A and a soft key associated with a z-a scrolling option 842B. In one arrangement, a user may select either the a-z or z-a option. Once the option is selected, the user may rotate the rotatable input knob 846 until a desired letter appears. In the example shown in FIGS. 7A-7J, the user Maria will be input. In such an instance, the knob 846 may be rotated until the “M” appears on the display, as shown in FIG. 7F. The chosen letter may be selected by pressing one of the soft key buttons or, alternatively, by pausing a predetermined amount of time before proceeding to the next letter. Once the “M” is input, the knob 846 may be rotated to the “a.” The user may continue this process until the name is input. Alternatively or additionally, the user may scroll through the alphabet by pressing or pressing and holding the soft key associated with the a-z option 842A or z-a option 842B. The user may stop at the appropriate letter and, after a predetermined time elapses, that letter will be selected. In yet another arrangement, one of the soft keys may be a rocker type key wherein pressing the upper portion of the key scrolls through the alphabet from a-z and pressing the lower portion of the key scrolls through the alphabet from z-a.

Once the name is input, as in FIG. 7G, the user may set this name as one of the saved users. In order to do this, a user may select the soft key associated with the exit option 862D. Selection of this option will prompt a display, such as shown in FIG. 7H. From this display 870, the user name may be saved by selecting the soft key associated with the “save” option 872A. Alternatively, the user may select a separate set option, such as button 355 in FIG. 1D. FIG. 7I illustrates one example of a user selection menu 880 after a user name has been saved. Additional user names may be stored by following the process described above and shown in FIGS. 7A-7I. If desired, provisions may be enabled to allow users to use cycles customized by other users. In the embodiments as depicted, cycles are limited to use by the user who saved the cycle.

In an alternate arrangement, the machine may come to a ready state in a non-multi-user mode or community mode. A community mode is generally a mode wherein there is no discrimination of operation based on a user. For instance, if the appliance is in a non-multi-user mode (e.g., a mode wherein the appliance cycles available for selection are those pre-stored, for instance, factory programmed settings), a cycle indicate page (506 in FIG. 3C) 3C may appear. This cycle indication page may generally indicate that the appliance is in a non-multi user mode. In addition, the cycle indication page 506 provides an indication of the cycle the appliance is currently set to run. In non-multi-user mode, the cycle may be one of a plurality of manufacturer stored cycles having various pre-set cycle parameters. In some arrangements, the cycle indication menu may indicate the cycle that was last used by the appliance.

In order to change the cycle displayed on the cycle indication page 506 to another of the manufacturer stored cycles, the user may input the change in a number of ways. For instance, the display may be a touch-sensitive display (shown in FIG. 2C), thereby allowing a user to simply select a change cycle icon. In another arrangement, the display region may include a plurality of soft keys arranged proximate the display region. In this arrangement, a user may select a soft key that corresponds to a “change cycle” indication on the cycle indication menu. In yet another arrangement, the user may rotate the rotatable input knob to select a different cycle from the plurality of manufacturer stored cycles. In each of these arrangements the display region may change to indicate the new cycle selected.

One advantage of the multi-user mode is that it allows each user to efficiently select a particular cycle because the wash parameters may be stored from the previous use. This eliminates additional time normally needed to customize each cycle parameter and simplifies the cycle selection process. In addition, the multi-user mode provides an increase in the number of cycles available on an appliance. For example, on a laundry appliance, such as a clothes washer or dryer, the available cycles not only include the manufacturer pre-stored cycles but also the plurality of customized cycles set by each user.

Another advantage to this arrangement of customizing cycles for a particular user is that it allows various users within a household to customize wash settings based on their preferences. These preferences will be available for future use. For instance, if one member of a household works in a profession wherein his or her work clothes may be heavily soiled, that user may customize a wash cycle for his or her work clothes that includes aggressive wash action to ensure that the wash load is fully cleaned. Rather than having to set various wash parameters for each load of work clothes that that user washes, he or she may select the customized “high soil” cycle, stored under that users cycles, to ensure that the desired wash cycle parameters are used for that cycle. In addition, using the stored cycle ensures consistency by providing the same wash cycle each time it is selected. It greatly reduces the opportunity for one wash cycle parameter to be selected in error. This is especially true as washing machines are sometimes installed in basements and garages where lighting conditions may be less than ideal.

In an alternate example, another household user may choose to wash all of his or her clothes in cold water to reduce shrinkage. In such an example, that user may establish one or more customized cycles that include a wash temperature of cold. Once those cycles are stored under that user's cycle directory, the user may select those cycles with the knowledge that the wash load will be done in cold water and minimal shrinkage will occur.

In yet another example, this system of customized cycles may be desirable in a household that includes children old enough to operate the washing machine but that may not fully understand the intricacies of choosing the wash cycle parameters. This arrangement may allow parents or other adults in the household to customize various cycles and save them to the customized cycle directory so that the child simply has to load the clothes, add soap and select the appropriate cycle name from the customized cycles display menu.

The arrangement described above may also be desirable in situations where many people are living in one home or building but have their own preferences for wash cycles, such as in a fraternity or sorority house, college dormitory or small apartment building in which multiple units share laundry facilities. This arrangement allows each user to customize various cycles for their use without concern that the cycle parameter settings may be adjusted.

The appliances associated with the user interface with multi-user mode may include various appliance functions. Each of these appliance functions may include one or more function parameters. For example, a washing machine may have a plurality of wash cycles as the appliance function, such as gentle, whites, normal, and the like. In addition, each wash cycle may have function parameters associated with it, such as spin speed, wash temperature, and the like. In another example, a clothes drying may have a plurality of drying cycles as appliance functions, such as permanent press, timed dry, and the like. In addition, the drying may include function parameters such as heat level, time, and the like. An oven may include appliance functions such as bake, broil, convection cook, and the like. In yet another example, a microwave may include appliance functions such as food specific cooking options (i.e., popcorn, vegetable, potato), defrost, time cook, and the like.

In one example arrangement, a user, for example, James, plays sports. James plays outdoor sports that tend to leave his clothes heavily soiled. Because of the generally heavy soil on his clothes, James prefers his wash cycle to include the hottest water temperature setting and the most aggressive spin cycle. In addition, James frequently does laundry so that he can use a small load setting. The multi-user mode as used on a washing machine allows James to customize a wash cycle for his “soccer clothes.” The cycle can be named that and can include the wash cycle parameters James desires. In addition, James' whites cycle also includes a hot water temperature and aggressive spin speed. Accordingly, when James selects the whites cycle from his available cycles, these cycle parameters are implemented.

James lives with Percy. Percy is less active than James and tends to be concerned about shrinkage with his clothing. Accordingly, Percy prefers a slow spin speed, warm wash water and, because Percy rarely does laundry, a high wash load. Percy has a cycle customized for his “chess tournament” clothes. The settings are more delicate than James' aggressive settings. In addition, when Percy does a load of whites, it is his slow spin speed and warm water temperature that will be implemented through selection of his user profile.

Because James and Percy live together, there is the opportunity for errors in laundry settings. By providing a user profile for each of James and Percy, each resident can be sure that there clothes will be laundered according to their preferences. In addition, neither James nor Percy is bogged down with customized cycles available for selection that do not include that user's preferences. James may choose from James customized cycles, while Percy may choose from his customized cycles. In addition, both James and Percy can be certain that, if a customized cycle is not chosen, the cycle they choose will include the parameter settings they applied the last time they ran the cycle. Therefore, Percy's white cycle will include his gentle spin speed and warm wash temp, while James' whites cycle will include an aggressive spin speed and hot water temperature.

In another example, Emeril and Rachel live together. Both enjoy baking cookies. However, Emeril prefers to bake his cookies at a high temperature for a short period of time. Rachel prefers to bake her cookies at a medium temperature for a longer period of time. The oven in Emeril and Rachel's house include a multi-user mode as described above. Emeril has three customized baking functions saved: one for oatmeal raisin cookies, one for chocolate chip cookies and one for sugar cookies. Rachel also has three cycles saved, one for chocolate fudge cookies, one for peanut butter cookies and one for chocolate chip cookies. By selecting the user profile for either Rachel or Emeril, the user can be certain that, although they may each have a saved setting for chocolate chip cookies, each user's cookies will be baked according to their customized baking parameters.

In light of the foregoing disclosure and description of various arrangements, those skilled in this area of technology will readily understand that various modifications and adaptations can be made without departing from the scope and spirit of the invention. All such modifications and adaptations are intended to be covered by the following claims.

What is claimed is:

1. A laundry appliance, comprising:
a user interface with a display region;
a plurality of soft keys arranged proximate the display region and configured for selection of menu items displayed on the display region;
a selection knob, wherein rotation of the knob indicates selection of a laundry cycle;
a plurality of user profiles stored within the laundry appliance and having a plurality of function parameters associated with each user profile, wherein the user profiles are selectable from a user selection menu displayed on the display region; and
a plurality of customizable laundry cycles, wherein selection of one of the plurality of user profiles determines function parameters for each of the plurality of customizable laundry cycles.

2. The laundry appliance of claim 1, wherein selection of a user profile from the user selection menu further determines the cycles available for selection with the selection knob.

3. The laundry appliance of claim 1, wherein the function parameters are wash cycle parameters.

4. The laundry appliance of claim 3, wherein the function parameters further include customizable user interface settings.

5. The laundry appliance of claim 3, wherein the plurality of wash cycle parameters include at least one of wash temperature, spin speed and soil level.

6. The laundry appliance of claim 1, wherein the plurality of user profiles are customizable.

7. The laundry appliance of claim 1, wherein the plurality of user profiles includes at least three stored users.

8. A method of operating a laundry appliance, comprising:
providing a user interface with a display region;
providing a first operating mode including a first plurality of cycles available for selection; and
providing a second operating mode including a second plurality of cycles available for selection;
enabling a user to select one of the first or second operating modes, wherein the first plurality of cycles of the first operating mode is based on user profiles and wherein the second plurality of cycles of the second operating mode is based on pre-stored parameters.

9. The laundry appliance of claim 8, wherein providing the first operating mode includes displaying user settings associated with a previous time a cycle was run by the user.

10. The laundry appliance of claim 8, further including providing an option for changing from the first operating mode to the second operating mode.

11. The laundry appliance of claim 8, further including selecting a cycle based on a position of a rotatable knob.

12. The laundry appliance of claim 8, wherein selection of the first operating mode or second operating mode is done via the user interface.

13. The laundry appliance of claim 8, wherein the second plurality of cycles includes at least one cycle that is saved for future use.

14. The laundry appliance of claim 8, further including selecting a cycle based on a previous cycle used.

15. The laundry appliance of claim 8, wherein the display region is a touch-sensitive display region.

16. The laundry appliance of claim 8, wherein the display region includes a plurality of soft keys arranged proximate the display region.

17. A method of operating a laundry appliance, comprising:
providing a user interface including a display region;
enabling the user interface to communicate with the laundry appliance;
selecting a user profile from a menu providing a plurality of user profiles, wherein the user profiles include a plurality of cycle parameters associated with each user profile;
selecting a cycle from a plurality of available cycles, wherein the available cycles include cycle parameters associated with the user profile selected; and
selecting a start button.

18. The laundry appliance of claim 17, wherein the plurality of cycle parameters are customizable.

19. The laundry appliance of claim 17, wherein the user profiles further include customizable user interface parameters.

20. The laundry appliance of claim 17, wherein the plurality of user profiles are customizable.
